(19) United States
(12) Patent Application Publication
(10) Pub. No.: US 2014/0302251 A1
(43) Pub. Date: Oct. 9, 2014

(54) RADIATION POLYMERIZABLE ABRASION RESISTANT AQUEOUS COATINGS

(71) Applicant: THE SHERWIN-WILLIAMS COMPANY, Cleveland, OH (US)

(72) Inventors: Garry A. Gbur, Homewood, IL (US); Hong Ding, Hudson, OH (US)

(73) Assignee: THE SHERWIN-WILLIAMS COMPANY, Cleveland, OH (US)

(21) Appl. No.: 13/836,905

(22) Filed: Mar. 15, 2013

(51) Int. Cl. C09D 7/12

(52) U.S. Cl. CPC C09D 7/1233
USPC 427/515; 524/535; 524/513

(57) ABSTRACT

A radiation polymerizable aqueous coating composition comprising:
(i) ethylenically unsaturated slime treated silica;
(ii) at least one water dispersible polyacrylate;
(iii) water dispersible ethylenically unsaturated oligomer; and
(iv) water.

This invention relates to water reducible radiation polymerizable coatings which cure to a substantially transparent film, and which have excellent abrasion resistance, hardness, flexibility, durability and adhesion. The coatings involve the use of colloidal silica particles which have been surface treated to provide ethylenic unsaturation. The coatings can be conveniently cured by actinic radiation having a wavelength less than about 4,000 Angstroms, such as ultraviolet and electron beam radiation. This invention also relates to a process for improving the abrasion resistance of a substrate by applying to at least one surface of the substrate the water reducible aqueous coating composition, allowing the coating to flash at ambient temperature, and polymerizing the coating by treatment with an effective amount of actinic radiation.

Synthetic polymeric substrates such as polymethyl methacrylate, polycarbonate, acrylonitrile butadiene styrene (ABS), and poly (allyl diglycol carbonate) (ADC), are lighter in weight and more resistant to shock and impact than glass products.

These synthetic materials are often less expensive and easier to mold than glass and are therefore used in many fields such as organic glass plates, windows for buildings and vehicles, illuminating device covers, optical lenses, reflectors, mirrors, displays, signboards, dust cover cases, and other plastic parts where glass would otherwise have been used. These synthetic polymeric materials, however, are typically very deficient in abrasion resistance and their surfaces are easily damaged by contact with other objects during their handling or use.

In order to improve the abrasion resistance of the synthetic polymers and other substrates, it is useful to coat the surface of the substrates with a material which is subsequently cured to provide abrasion resistance and durability. Water reducible coatings are desirable for many of these applications, but the relatively large quantities of water frequently required to achieve desirable viscosities for ease of application by spray or other application techniques may require prolonged and/or heated flash off times to remove the water prior to cure since any remaining water could adversely affect gloss and cure. Heated flash off processes, however, are energy inefficient and the heat can lead to softening or attack on the substrate itself. Maintaining stability of the organic and inorganic materials dispersed in the coatings can also be difficult in water borne coatings.

The water reducible compositions of this invention provide stable coatings requiring minimal flash off at ambient temperatures along with excellent adhesion and protection for plastic and other substrates.

In one embodiment, the radiation polymerizable aqueous coating compositions of this invention comprise ethylenically unsaturated silane treated silica, at least one water dispersible polyacrylate, a water dispersible ethylenically unsaturated oligomer, and water. Optionally they may also contain water miscible solvents, such as lower molecular weight alcohols and ethers, flow agents, wetting agents, catalysts or initiators, adhesion promoters, and other additives as are known in the art. The coatings will typically be applicable at 70% NVM or higher. To the extent that water and/or organic solvent is required, the coatings at application viscosity (typically less than 1.0 poise) may comprise about 5 to about 25% (and sometimes 7 to about 15%) water, and typically 0 to about 15% (and sometimes 1 to about 10%) water miscible organic solvent based upon the total weight of the coating.

In some embodiments the water reducible coatings would comprise on a weight solids basis based upon the total weight of (i) and (ii) and (iii):
(i) 10-60% (and sometimes 10-35%) ethylenically unsaturated silane treated silica;
(ii) 10-60% (and sometimes 10-45%) of at least one water dispersible polyacrylate; and
(iii) 5-60% (and sometimes 5-45%) of at least one water dispersible ethylenically unsaturated oligomer.

In some particular embodiments, the water reducible coatings would comprise on a weight solids basis based upon the total weight of (i) and (ii) and (iii) and (iv):
(i) 10-50% ethylenically unsaturated silane treated silica;
(ii) 15-40% water dispersible diacrylate;
(iii) 5-25% water dispersible polyacrylate having an average of more than two acrylate groups per molecule; and
(iv) 5-60% water dispersible ethylenically unsaturated oligomer.

### 1. Ethylergically Unsaturated Siloam Treated Silica

The ethylenically unsaturated silane treated silica imparts hardness and durability and will crosslink with the other unsaturated materials through the unsaturated functionality when the coating is cured. The silica is treated by reaction with a reactive silane, such as an alkoxy silane having ethylenic unsaturation. For some preparations, the silica will be provided as a silica organosol, usually as a dispersion of silica in an organic solvent. The silica may have an average particle size less than about 100 nm and often less than about 50 nm. The organic solvent conveniently can be a lower molecular weight alcohol, ether alcohol, ketone or other suitable solvent.

Representative ethylenically unsaturated silanes include acrylate functional silanes such as 3-acryloxypropyltrimethoxysilane, 2-methacryloxyethyltrimethoxysilane, 2-acryloxyethyltrimethoxysilane, 3-methacryloxypropyltriethoxysilane, 2-methacryloxyethyltriethoxysilane, 2-acryloxyethyltriethoxysilane, gamma glycidoxypropyltrimethoxysilane, and gamma methacryloxypropyltrimethoxysilane, and vinyl functional silanes such as vinyltrimethoxysilane, vinyltriethoxysilane, and vinyltri(2-methoxyethoxy)silane. For some embodiments, dialkoxysilanes, such as vinylmethyldimethoxysilane and vinylmethyldiethoxysilane, and monoalkoxysilanes could also be used as partial or total replacements for the trialkoxysilanes. For some embodiments the trialkoxy acrylate silanes are useful. The level of ethylenically unsaturated silane treatment will typically provide at least about 1% by weight of the weight of the silica, and often will provide between 5 and 35% by weight of the silica as the ethylenically unsaturated silane.

Non ethylenically unsaturated silanes such as methyltrimethoxysilane, propyltriethoxysilane, methyltriisopropoxysilane, gamma chloropropyltrimethoxysilane, gamma glycydoxypropyltriethoxysilane, beta glycydoxyethyltrimethoxysilane, 3,3,3-trifluoropropyltrimethoxysilane, 3,4-epoxycyclohexyl-ethyltriethoxysilane, phenyltrimethoxysilane, vinyltriethoxysilane, vinyltrimethoxyethoxysilane, N-beta(aminoethyl) gamma aminopropyltrimethoxysilane, gamma mercaptopropyltrimethoxysilane, and beta cyano ethyltriethoxysilane, etc. can be used in combination with the unsaturated silanes if desired.

Typically the treatment process involves admixing the silane and silica organosol in the presence of an acid catalyst at temperatures ranging up to about 120° C., and typically at temperatures ranging between about 60° C. and 110° C. to complete the reaction and to distill off the organic solvent and the by-products of the silane/silica reaction. For certain embodiments of this invention it is useful to add all or at least a portion of the water dispersible polyacrylates to the heated product of the silane and silica reaction in order to provide greater long term stability to the final coating product. This addition can take place before all of the organic solvent and reaction by products have been distilled off. Although it is not our intent to be bound by theory, it appears that adding the water dispersible polyacrylates to the heated silane treated silica enhances the mutual solubility/dispersibility of the materials and provides a compatible environment for the silane treated silica product. The addition of the polyacrylates can be conducted at any temperature below the boiling point of the polyacrylates, and typically is added when the reaction mixture is at least 30° C., and often at least 60° C.

### 2. Water Dispersible Polyacrylate

At least one water dispersible polyacrylate is also included in the aqueous coating composition. As used herein, “water dispersible” means that the polyacrylate can be stabily dispersed in the aqueous coating without phase separation or hard settling that cannot be redispersed. Water dispersible polyacrylates can be conveniently obtained as esters of acrylic or methacrylic acid with polyethylene glycol, or with a mono-, di-, tri-, or tetra-hydric alcohol derived by ethoxylating a mono-, di, tri-, or tetra-hydric aliphatic alcohol with ethylene oxide. Examples of these are acrylate esters of polyethylene glycols made from a polyethylene glycol and acrylic or methacrylic acid. In some embodiments, these esters will have a molecular weight of from 200 to 1500, or for some embodiments from 400 to 1000, or for some embodiments from 400 to 800. Other representative commercially available water dispersible polyacrylates include the acrylic esters of ethoxylated trimethylolpropane, for some embodiments having from 3 to 30 ethoxylate residues.

Combinations of polyacrylates, such as a combination of one or more water dispersible diacrylates, and of one or more water dispersible polyacrylates having more than two acrylate groups, is useful in some embodiments.

### 3. Water Dispersible Ethylenically Unsaturated Oligomers

The radiation polymerizable coatings will also incorporate a water dispersible ethylenically unsaturated oligomer which can be copolymerized with the silane treated silica and polyacrylates upon cure. Useful oligomers are water-dispersible urethane, polyester, polyamide, polyurea, melamine, or epoxy resins containing ethylenic unsaturation such as acrylate or methacrylate ester groups.

The oligomers will typically have a number average molecular weight of at least about 700 and often will range from about from 750 to about 2800. The oligomers will have an average of at least two polymerizable ethylenically unsaturated groups per molecule and may have ether linkages, hydroxyl groups, or ionic groups to provide water dispersibility. For some embodiments, water dispersible unsaturated hyperbranched polyesters are useful. Acrylate functional hyperbranched unsaturated polyesters are commercially available and can be representatively prepared by the reaction of a hyperbranched polyol with, for example, acrylic or methacrylic acid, or by reaction of multifunctional polyols and multifunctional acids or anhydrides and subsequent reaction with, for example, glycidyl methacrylate.

### 4. Additional Materials

The coatings of this invention can also incorporate other materials known in the art. If desired, organic. solvents, typically less than 150%, and often less than 10% by weight of the coating composition, can be added. Generally these solvents should be low boiling alcohols or similar materials that will evaporate quickly from the film once it is applied to minimize flash off time.

Typically, the coatings will also contain an effective catalytic amount, usually about 0.1 to about 8% by weight of the polymerizable compounds, of a free radical polymerization initiator, such as a photo initiator, to facilitate cure of the coating after application. Typical photoinitiators include benzophenone. Michler's ketone, diethoxyacetophenone, 2-chlorothioxanthone hydroxy-alkyl phenones, and other materials known in the art.

The compositions of this invention can be conveniently applied as a coating to a substrate, allowed a short flash time (often fifteen minutes or less even at ambient temperatures) and cured by exposure to an effective amount of actinic radiation having a wavelength less than about 4,000 Angstroms such as electron beam or ultraviolet light radiation. The exposure need only be long enough to provide the desired amount of cure. The time required for cure depends on the intensity of the incident radiation, but typically sufficient cure can be obtained in one minute or less. Typical doses of ultraviolet radiation range from about 5 to about 150 feet/minute/lamp while useful doses of electron beam radiation range from about 0.5 to about 15 megarads.

It would also be possible to cure the coatings of the invention by any other free radical initiator, e.g. visible light initiators such as taught in U.S. Pat. No. 3,650,699 or U.S. Pat. No. 4,071,424 or by subjecting the coatings to heat in the presence of a heat-sensitive free radical initiator. Although these methods may he useful, they are not preferred for most embodiments because the thermal initiators are undesirable for heat-sensitive substrates and are less energy efficient than curing by exposure to radiation, and the visible light initiators often require special handling to avoid premature polymerization.

As used herein, unless otherwise stated, the term “parts” means parts by weight, percentages are percent by weight and viscosity is Gardener Holdt.

One process for preparing a stable solution of the ethylenically unsaturated silane treated silica involves an initial stage of charging a reaction vessel with a portion of a silica organosol (for some applications the organosol will be a solution of a colloidal silica in an alcohol solvent), a polymerization inhibitor and/or an antioxidant, and a catalytic amount of an acid (for some applications, glacial acetic acid) and heating the mixture to a suitable reaction temperature often above about 40° C. (for some applications this may be below the boiling point of the solvent of the silica organosol and higher than the methanol boiling point and typically is in a range of 60-80° C.). In a second stage of this process, a mixture of any remaining portion of the silica organosol to be treated and an ethylenically unsaturated alkoxy silane are gradually (for some applications over a period of approximately two hours) added to the heated mixture and held to allow the alkoxy silane to react with the silica particles. In a third stage one or more water dispersible polyacrylates will be added to the heated mixture and the reaction mixture heated to a temperature to distill off the majority of the solvent from the starting silica organosol and the reaction by-products of the silane reaction with the silica. After the reaction has reached the desired level of completion and the distillate removed, the reaction mixture can then be cooled filtered and discharged. The following example is representative of this approach.

### EXAMPLE 1

A four necked reaction vessel equipped with a horizontal condenser, thermometer, stirrer, gas inlet and addition funnels was charged with 734.4 parts TA-ST (30.5% colloidal silica in isopropanol, having an average particle size of 10-15 nm, available from Nissan Chemical Company) and 0.1208 parts phenothiazine, and 4.0 parts Doverphos® 6 antioxidant under agitation and air blanket. Glacial acetic acid (11.0 parts) was then slowly added to the reactor over 2 minutes. The mixture was stirred and heated to 74° C. and a mixture of IPA-ST (311.8 parts) and 45.8 parts Silquest® A-174 (gamma methacryloxypropyltrimethoxysilane available from Momentive Performance Materials, Inc.) was then added to the hot silica suspension over a period of about 2 hours, and then held at that temperature for an additional hour. 896.8 parts Miramer® M284 (polyethylene glycol diacrylate having a molecular weight of approximately 408 available from Rahn USA Corp.) was then added to the reaction mixture and the reaction temperature was gradually increased to 104° C. and about 700 parts of distillate was collected. The mixture was then cooled to 40° C., filtered, and discharged. The resulting product had a weight per gallon of 10.40 lb/gallon and a Gardener-Holdt viscosity of A.

### EXAMPLE 2

The process of Example 1 was repeated except that the first phase involved 367.2 parts IPA-ST, 0.0604 parts phenothiazine, 2.0 parts Doverphos® 6 antioxidant, and 5.5 parts glacial acetic acid, the second phase involved a mixture of 155.9 parts TA-ST and 22.9 parts Silquest A-174, and the third phase involved 448.4 parts Miramer® M3190 (TMPEO9TA—nine mole ethoxylated trimethylol propane triacrylate from Rahn). The resulting product had a weight per gallon of 10.20 pounds per gallon and a viscosity of B-C.

### EXAMPLE 3

The process of Example 2 was repeated except that the third phase involved 448.4 parts Sartomer® SR415 (TMPEO2TA—two mole ethoxylated trimethylol propane triacrylate from Sartomer). The resulting product had a weight per gallon of 10.40 pounds per gallon and a viscosity of J-K.

### EXAMPLE 4

The process of Example 1 was repeated except that the third phase involved 896.8 parts Sartomer® SR9035 (TMPEO15TA—fifteen mole ethoxylated trimethylol propane triacrylate from Sartomer). The resulting product had a weight per gallon of 10.40 pounds per gallon and a viscosity of G.

### EXAMPLE 5

The process of Example 1 was repeated except that the third phase involved 896.8 parts Sartomer® SR259 (PEG200DA—polyethylene glycol diacrylate having a number average molecular weight of about 300 from Sartomer). The resulting product had a weight per gallon of 10.40 pounds per gallon and a viscosity of A2.

### EXAMPLE 6

The process of Example 1 was repeated except that the first phase involved 1496.6 parts 1PA-ST-L (30.5% 40nm silica in isopropanol from Nissan Chemical), 0.0836 parts phenothiazine, and 11.2 parts glacial acetic acid, the second phase involved a mixture of 635.4 parts 1PA-ST-L and 913 parts Silquest A-174, and the third phase involved 556.3 parts Miramer® M284. The resulting product had an NVM of 97.9%, a weight per gallon of 11.76 pounds per gallon and a viscosity of Z10.

### EXAMPLE 7

The process of Example 1 was repeated except that the first phase involved 1496.6 parts IPA-ST, 0.0836 parts phenothiazine, and 11.2 parts glacial acetic acid, the second phase involved a mixture of 635.4 parts 1PA-ST and 93.3 parts Silquest A-174, and the third phase involved 556.3 parts Sartomer SR494 (four mole ethoxylated pentaerythritol tetraacrylate having a molecular weight of approximately 573 available from Sartomer). The resulting product had an NVM of 92.8%, a weight per gallon of 11.78 pounds per gallon and a viscosity of Z9.

### EXAMPLE 8

The process of Example 1 was repeated except that the first phase involved 854.1 parts IPA-ST, 0.11 parts phenothiazine, and 11.3 parts glacial acetic acid, the second phase involved a mixture of 362.6 parts IPA-ST and 53.3 parts Silquest A-174, and the third phase involved 719.2. parts

Miramer® M284 and 156.3 parts Miramer M31.90. The resulting product had an NVM of 97.0%, a weight per gallon of 10.69 pounds per gallon and a viscosity of B-C.

### EXAMPLE 9

The process of Example 1 was repeated except that the first phase involved 1041.2 parts IPA-ST, 0.058 parts phenothiazine, and 9.9 parts glacial acetic acid, the second phase involved a mixture of 442.1 parts 1PA-ST and 64.9 parts Silquest A-174, and the third phase involved 587.0 parts Miramer® M2.84 and 195.7 parts Miramer M3190. The resulting product had an NVM of 96.1%, a weight per gallon of 10.99 pounds per gallon and a viscosity of E-F.

Representative coatings were prepared using the ethylenically unsaturated silicia polyacrylate mixture of Example 9.

| | PAINT EXAMPLE | | | | | | | | |
|---|---|---|---|---|---|---|---|---|---|
| | A | B | C | D | E | F | G | H | I |
| Treated Silicia | 107.5 | 107.5 | 107.5 | 107.5 | 107.5 | 107.5 | 104.2 | 111 | 440 |
| Solution | | | | | | | | | |
| CN2303 (1) | 81.1 | 118.7 | | | | | 78.2 | 132.2 | 176 |
| CN2302 (2) | | | 81.1 | 118.7 | | | | | |
| CN2304 (3) | | | | | 81.1 | 118.7 | | | |
| Tego ®Glide 410 (5) | 0.76 | 0.76 | 0.76 | 0.76 | 0.76 | 0.76 | 0.74 | 0.85 | 3.1 |
| Irgacure ®500 (6) | 4.5 | 5.6 | 4.5 | 5.6 | 4.5 | 5.6 | 5.4 | 6.9 | 13.9 |
| Byk ®021 | | | | | | | | 3.3 | |
| N-Butanol | 7.6 | 7.6 | 7.6 | 7.6 | 7.6 | 7.6 | 7.5 | | 35 |
| Monobutyl | 7.6 | 7.6 | 7.6 | 7.6 | 7.6 | 7.6 | 7.5 | 7.04 | 35 |
| Ether Ethylene | | | | | | | | | |
| Glycol | | | | | | | | | |
| DI water | 30.1 | 30.1 | 30.1 | 30.1 | 30.1 | 30.1 | 29.5 | 28.6 | 140 |
| Isopropyl | | | | | | | | 14.1 | |
| Alcohol | | | | | | | | | |

(1) Hyperbranched polyester acrylate oligomer from Sartomer Company, Inc,
(2) Hyperbranched polyester acrylate oligomer from Sartomer Company, Inc,
(3) Hyperbranched polyester acrylate oligomer from Sartomer Company, Inc.
(4) Water dilutable aliphatic urethane acrylate oligomer available from Dymax
(5) Flow additive available from Evonik Industries
(6) Photoinitiator (50/50) mixture of 1-hydroxy-cyclohexyl-phenyl-ketene and benzophenose available from BASF Chemical Company

The coating examples were spray applied to ABS substrate, allowed to flash about ten minutes and cured by exposure to a 400 watt H bulb to provide a dry film thickness of about 0.9 mils. Abrasion resistance is measured by placing the coated samples in a Rosier Trough Vibrator filled with wear media, water and detergent and vibrated for a period of three hours. Change in 60 degree and 20 degree gloss is measured. The cured panels gave the following results:

| | | | | | % |
|---|---|---|---|---|---|
| PAINT | Initial 60° | Final 60° | Initial 20° | Final 20° | Retention |
| EXAMPLE | Gloss | Gloss | Gloss | Gloss | 20° Gloss |
| A | 88.6 | 83 | 78.7 | 69.7 | 88.6 |
| B | 89.1 | 86.5 | 79.5 | 74.1 | 93.2 |
| C | 87.7 | 78.6 | 78.2 | 60.4 | 77.2 |
| D | 89.1 | 83.5 | 80.2 | 68.0 | 84.8 |
| E | 88.2 | 75.8 | 78.9 | 58.2 | 73.8 |
| F | 89.6 | 80.0 | 80.3 | 61.5 | 76.6 |
| G | 83.3 | 72.8 | 64.1 | 55.7 | 86.9 |
| H | 86.9 | 82.3 | 75.5 | 66.4 | 87.9 |
| I | 88.2 | 78.8 | 78.8 | 67.5 | 85.6 |

While this invention has been described by a specific number of embodiments, it is obvious that other variations and modifications may be made without departing from the spirit and scope of the invention as set forth in the appended claims.

Paint examples A through I all showed excellent abrasion resistance.

The invention claimed is:

1. A radiation polymerizable aqueous coating composition comprising:
(i) ethylenically unsaturated silane treated silica;
(ii) at least one water dispersible polyacrylate;
(iii) water dispersible ethylenically unsaturated oligomer; and
(iv) water.

2. The coating composition of claim 1 wherein the composition also comprises a water-miscible organic solvent.

3. The composition of claim 1 wherein the at least one water dispersible polyacrylate is an ethoxylated polyacrylate.

4. The composition of claim 1 wherein the at least one polyacrylate comprises a diacrylate.

5. The composition of claim 1 wherein the at least one polyacrylate comprises a polyacrylate having an average of more than two acrylate groups per molecule.

6. The composition of claim 1 wherein the at least one water dispersible polyacrylate comprises a diacrylate and a polyacrylate having an average of more than two acrylate groups per molecule.

7. The composition of claim 1 wherein the composition comprises, on a weight solids basis:
(i) 10-60% ethylenically unsaturated silane treated silica;
(ii) 10-60% at least one water dispersible polyacrylate; and
(iii) 5-60% water dispersible ethylenically unsaturated oligomer,
based upon the combined total weight solids of (i) and (ii) and (iii).

8. The composition of claim 7 wherein the composition comprises: on a weight solids basis:
(i) 10-35% ethylenically unsaturated silane treated silica;
(ii) 10-35% at least one water dispersible polyacrylate; and
(iii) 5-45% water dispersible ethylenically unsaturated oligomer,
based upon the combined total weight solids of (i) and (ii) and (iii).

9. The composition of claim 7 wherein the composition comprises:
(i) 10-50% ethylenically unsaturated silane treated silica;
(ii) 15-40% water dispersible diacrylate;
(iii) 5-25% water dispersible polyacrylate having an average of more than two acrylate groups per molecule; and
(iv) 5-60% water dispersible ethylenically unsaturated oligomer,
based upon the total weight solids of (i) and (ii) and (iii) and (iv).

10. The composition of claim 1 further characterized in that the composition also contains a catalytic amount of a polymerization catalyst.

11. The composition of claim 1 wherein the ethylenically unsaturated silane treated silica was obtained b y a process which comprises:
(1) admixing an ethylenically unsaturated silane and a catalytic amount of acid with a silica organosol comprising silica dispersed in a water-miscible organic solvent; and
(ii) gradually adding an ethylenically unsaturated alkoxysilane to the admixture under reactive conditions; and
(iii) adding at least some of the water dispersible polyacrylate to the admixture while maintaining the admixture.

12. The coating composition of claim 1 wherein the water dispersible ethylenically unsaturated oligomer is an unsaturated hyberbranched polyester.

13. The coating composition of claim 1 wherein the water is present at about 5 to 15% by weight of the total coating.

14. The coating composition of claim 1 wherein the coating also comprises an organic solvent.

15. The coating composition of claim 14 wherein the organic solvent is present at a level of 1 to about 10% by weight of the total weight of the coating composition.

16. A process for improving the abrasion resistance of a substrate which process comprises applying to at least one surface of the substrate an aqueous coating composition, allowing the coating to flash at ambient temperature, and polymerizing the coating by treatment with an effective amount of actinic radiation; wherein the radiation polymerizable coating comprises:
(i) ethylenically unsaturated silane treated silica;
(ii) at least one water dispersible polyacrylate;
(iii) water dispersible ethylenically unsaturated oligomer; and
(iv) water.
